(19) United States
(12) Patent Application Publication
(10) Pub. No.: US 2002/0063369 A1
(43) Pub. Date: May 30, 2002

(54) Rubber shock absorber

(76) Inventor: Kou-Ming Huang, Taichung (TW)

Correspondence Address: Keith Kline, PRO-TECHTOR INTERNATIONAL SERVICES, 20775 Norada Court, Saratoga, CA, 95070-3018, US

(21) Appl. No.: 09/727,655

(22) Filed: Nov. 30, 2000

(51) Int. Cl. F16F 1/36; F16F 7/00

(52) U.S. Cl. 267/153; 267/292

(57) ABSTRACT

A rubber shock absorber, comprising a shock absorbing device body. The shock absorbing device body is made of elastic material, mounted in a shock absorbing device and absorbs pressure to which said shock absorbing device is exposed. The shock absorbing device body consisting of a plurality of sections with different diameters and different elastic coefficients. Peripheral grooves are cut into the shock absorbing device body at interfaces between the sections thereof. The shock absorbing device body has an elastic coefficient that varies in several stages, so that during an absorption process stages of different absorption characteristics are gone through.

### BACKGROUND OF THE INVENTION

1. Field of the Invention

The present invention relates to a rubber shock absorber, particularly to a rubber shock absorber used in a shock absorbing device in a car, a motorcycle or a bicycle.

2. Description of Related Art

A conventional shock absorbing device has an elastic attenuating element which usually is a coil spring made of metal, a metal plate spring, a rubber shock absorber, or a device with an oil absorber or a gas absorber. Among these, rubber shock absorbers, due to simple structure and low weight, are often used in light absorbing devices.

A conventional rubber shock absorber mostly has a tube-like structure around a longitudinal central hole. For use, the tube-like structure is cut to a suitable length according to demand, then a guiding rod is passed through the central hole, guiding the rubber shock absorber when deformed. The rubber shock absorber, when pressure is applied to two ends thereof, deforms longitudinally, absorbing energy.

However, a conventional rubber shock absorber has only a single elastic coefficient. Therefore in a shock absorbing device with a rubber shock absorber, shock absorbing is characterized by just a single elastic coefficient. On the other hand, in practice a shock absorbing device, for better driving comfort and stability, is designed to have a relatively small elastic coefficient in a beginning stage of absorbing. Thus small shocks are already absorbed, while larger shocks are taken with a relatively large elastic coefficient for withstanding dynamic forces due to improper counterbalancing and violent vertical vibrations during driving.

For achieving above object, the elastic attenuating element in the shock absorbing device is designed to have an elastic coefficient changing in several sections, or a plurality of elastic attenuating elements is combined to ensure different elastic coefficients of the shock absorbing device in various stages.

However, this requires to arrange a plurality of rubber shock absorbers with different elastic coefficients along an axis, leading to an increased length of the shock absorbing device and a complicated structure thereof.

Besides this, shock absorbing devices which combine oil and gas absorbers with elastic elements have been designed to achieve a better attenuation effect. The complicated structure of oil and gas absorbers, however, leads to a high cost of the shock absorbing device. Furthermore, leaking of oil or gas easily annihilates the attenuating effect.

### SUMMARY OF THE INVENTION

The main object of the present invention is to provide a rubber shock absorber with an elastic coefficient changing between several values for an enhanced attenuating effect.

Another object of the present invention is to provide a rubber shock absorber, resulting in a simple structure of a shock absorbing device and having a small volume.

The present invention can be more fully understood by reference to the following description and accompanying drawings.

### BRIEF DESCRIPTION OF THE DRAWINGS

FIG. 1 is a perspective view of the shock absorbing device body of the present invention.

FIG. 1A is a side view of the shock absorbing device body of the present invention.

FIG. 2 is a sectional view of the present invention used in conjunction with a bicycle fork shock absorbing device.

FIG. 3 is a side view of the present invention in the second embodiment.

FIG. 4 is a side view of the present invention in the third embodiment.

FIG. 5 is a side view of the present invention in the fourth embodiment.

FIG. 6 is a perspective view of the present invention in the fifth embodiment.

FIG. 7 is a sectional view of the present invention in the sixth embodiment.

FIG. 8 is a sectional view of the present invention used in conjunction with a bicycle rear shock absorbing device.

### DETAILED DESCRIPTION OF THE PREFERRED EMBODIMENTS

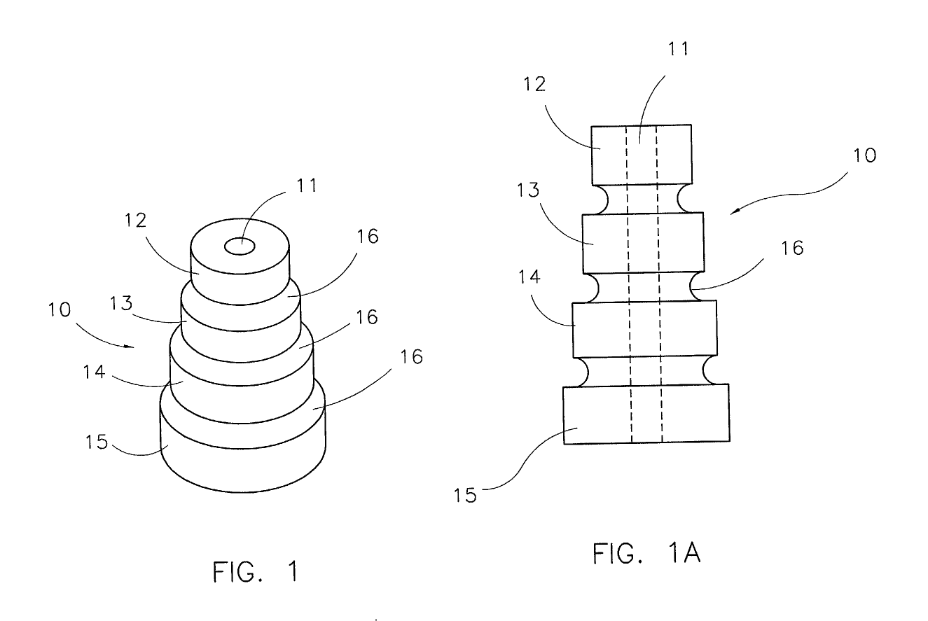

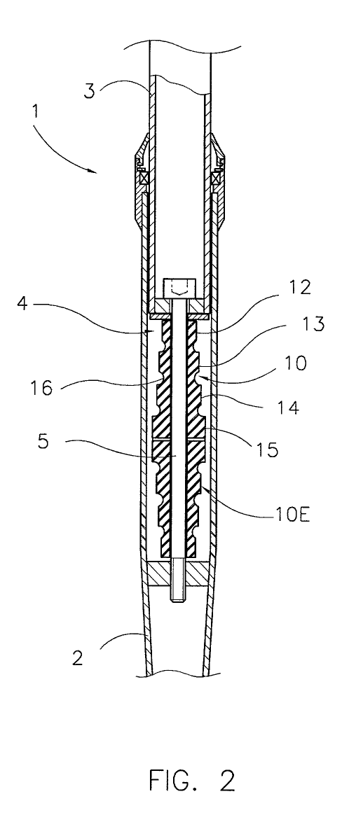

As shown in FIGS. 1 and 1A, the rubber shock absorber of the present invention mainly comprises a shock absorbing device body 10, made of highly elastic material, like rubber or PU. The shock absorbing device body 10 has a through hole 11 along a longitudinal axis, accommodating a guiding rod that passes through the shock absorbing device body 10 along the longitudinal axis. As shown in FIG. 2, the shock absorbing device body 10 is mounted on a shock absorbing device 1, absorbing shocks that are taken by the shock absorbing device 1 from a wheel in contact with the ground.

The body of the present invention is roughly shaped like a column with a triangular, quadrangular, pentagonal, hexagonal or circular cross-section. For simplicity, in the following a circular cross-section is taken as an example, without the present invention being restricted thereto.

Referring again to FIG. 2, the shock absorbing device 1 comprises: an outer tube 2, an inner rod 3, an accommodating chamber 4, and a guiding rod 5. The outer tube 2 has a lower end, connected with the wheel. The inner rod 3 slides telescopically within the outer tube 2. The accommodating chamber 4 is located inside the outer tube 2, accommodating the shock absorbing device body 10 and a shock absorbing device body 10E, which absorb shocks that are taken by the shock absorbing device 1. The inner rod 3 has a lower end that is inserted into the shock absorbing device 1 and is in contact with the shock absorbing device bodies 10, 10E. When vibrations or a force are exerted on the shock absorbing device 1, the inner rod 3 moves closer towards the outer tube 2, compressing the shock absorbing device bodies 10, 10E between the lower end of the inner rod 3 and a fixed lower part of the outer tube 2. The guiding rod 5 passes longitudinally through the shock absorbing device body 10E and, further above, through the through hole 11 of the shock absorbing device body 10. The guiding rod 5 ensures that the shock absorbing device bodies 10, 10E are only deformed longitudinally when compressed and will not bend.

Referring again to FIG. 1, the main characteristic of the present invention is that the shock absorbing device body 10 consists of several sections 12, 13, 14, 15. The sections 12, 13, 14, 15 have interfaces which each are bordered by a peripheral groove 16. Due to different diameters, the sections 12, 13, 14, 15 have different elastic coefficients. Therefore the shock absorbing device body 10, when longitudinally compressed, exhibits an elastic coefficient which varies in several stages.

When the shock absorbing device 1 starts to undergo a shock, the shock absorbing device body 10 is compressed by the inner rod 3. The section 12, which has the smallest diameter and the smallest elasticity coefficient starts to deform. In this stage, the shock absorbing device has a soft absorbing characteristic, providing for comfortable driving. With a larger force exerted on the shock absorbing device, the section 12 of the shock absorbing device body 10 is compressed to an extreme degree, and the larger sections 13, 14, 15 start to deform. Then the shock absorbing device body 10 has a larger elasticity coefficient, and the shock absorbing device has a harder absorbing characteristic, taking in relatively large shocks and forces.

The main advantage of the arrangement of the present invention described above is, since the shock absorbing device body 10 consists of several sections 12, 13, 14, 15 of different diameters and elastic coefficients, that the shock absorbing device body 10 has a varying compressibility in various stages of compression. Using of a plurality of attenuating elements in the shock absorbing device is not required to achieve an elastic coefficient varying in stages. Thus the present invention not only satisfies the demand of a varying elastic coefficient during the absorption process, but also works with a reduced number of elastic attenuating elements and allows a reduced length of the shock absorbing device.

For using the shock absorbing device body 10 of the present invention, the section 12 with the smallest diameter is placed on top in the shock absorbing device or, alternatively, at the bottom therein. Thus the shock absorbing device as a varying absorption characteristic during use.

Besides achieving the object of a varying elastic coefficient by employing the sections 12, 13, 14, 15 with different diameters, by varying width, depth and number of the peripheral grooves 16, a shock absorbing device body 10A obtains modified elastic coefficients at every longitudinal position.

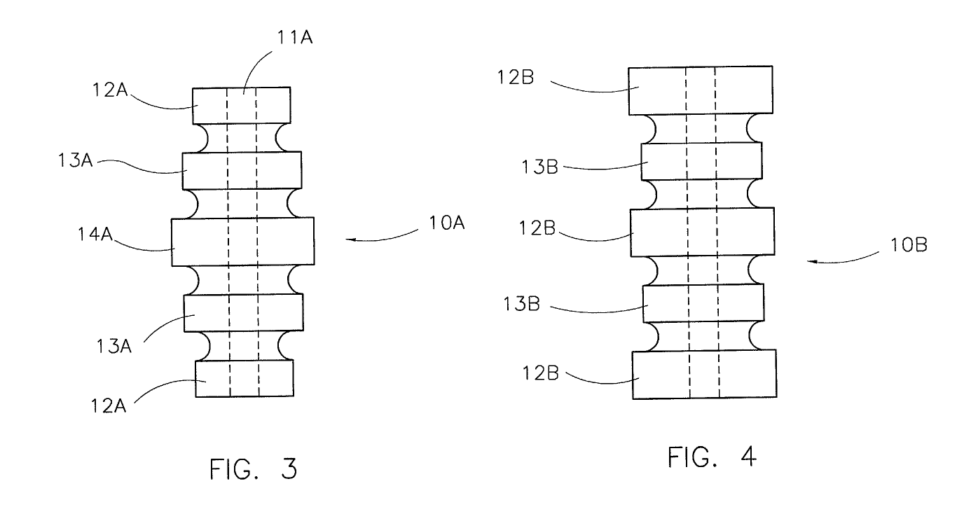

Furthermore, variation of section diameters along the shock absorbing device body of the present invention is not restricted to increasing diameters of above embodiment. As shown in FIG. 3, a shock absorbing device body 10A has a section 14A at a middle position with a relatively large diameter. On two sides of the sections 14A, sections 12A, 13A are placed with decreasing diameters. The sections 12A, 13A are arranged symmetrically. Therefore, when the shock absorbing device body 10A is exposed to pressure, a doubled degree of deformation takes place, leading to a relatively large absorption capability of the shock absorbing device body. Moreover, as shown in FIG. 4, in a third embodiment, a shock absorbing device body 10B has sections 12B of relatively large diameter alternating with sections 13B of relatively small diameter.

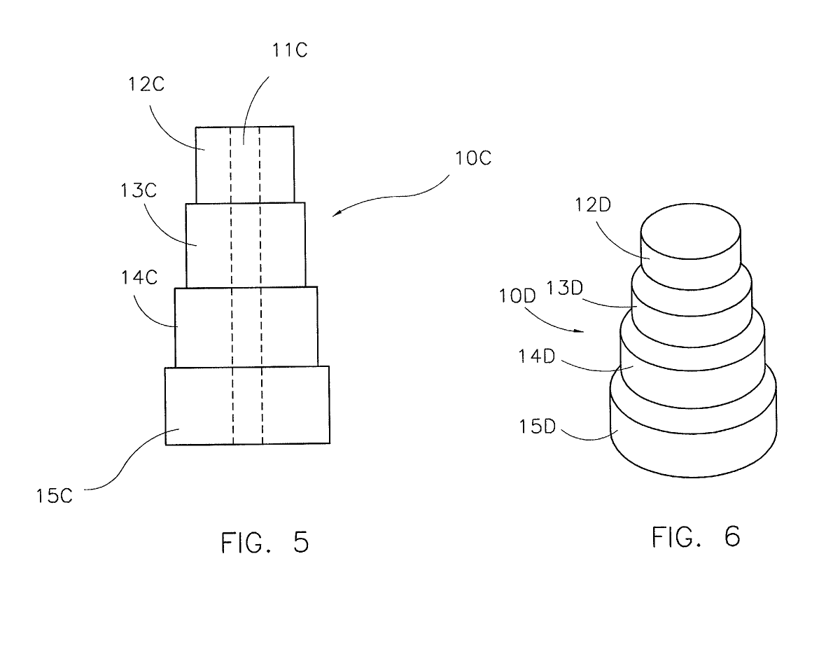

The shock absorbing device body 10 of the present invention has many simplifications. As shown in FIG. 5, in another embodiment a shock absorbing device body 10C has sections 12C, 13C, 14C, 15C with interfaces which have no grooves. As shown in FIG. 6, in another embodiment a shock absorbing device body 10D has no longitudinal through hole to be used within a shock absorbing device without a guiding rod.

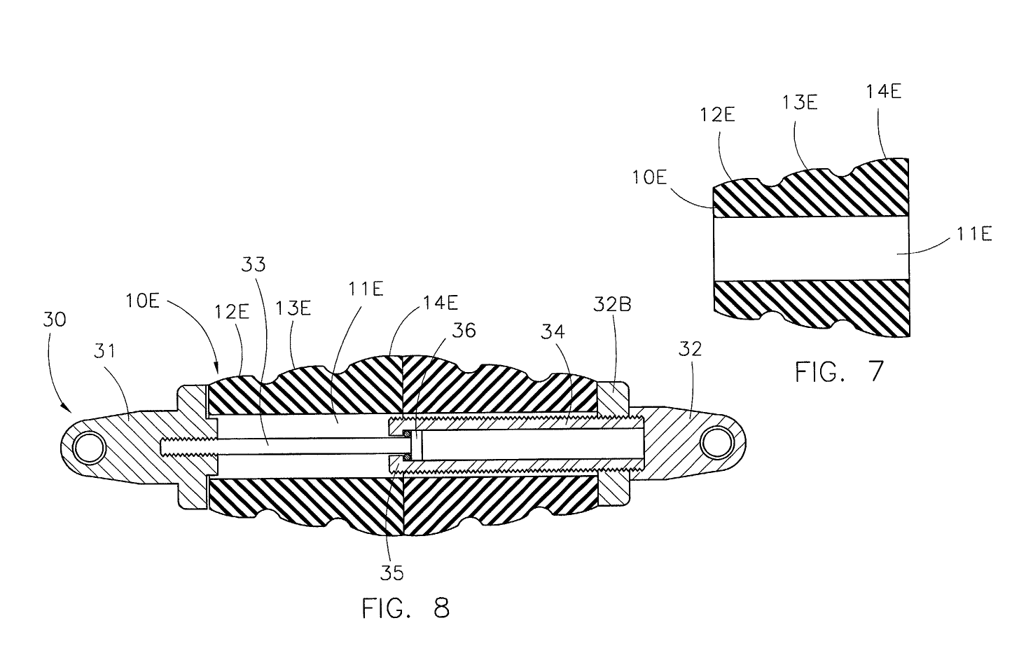

Referring to FIG. 7, a shock absorbing device body 10E has a longitudinal through hole 11E and three sections 12E, 13E, 14E of different diameters. The sections 12E, 13E, 14E are arranged with decreasing diameters, having inclined peripheral surfaces, providing for a better deforming ability of the shock absorbing device body.

FIG. 8 shows the shock absorbing device body 10E mounted in a bicycle rear shock absorbing device 30. The bicycle rear shock absorbing device 30 has two connecting seats 31, 32. A connecting rod 33 is inserted in the connecting seat 31. An adjusting nut 32 B is placed on the connecting seat 32, and a tube 34 is inserted therein at a central position. The tube 34 has a far end to which a holding element is attached. The connecting rod 33 has a far end inserted in the tube 34 and carrying a blocking element 36 held by the holding element 35. Since the connecting rod 33 and the tube 34 keep the connecting seats 31, 32 on a common longitudinal axis, movements thereof are performed along the longitudinal axis back and forth within a certain range. Two shock absorbing device bodies 10E are placed between the connecting seats 31, 32. The connecting rod 33 and the tube 34 pass through the through holes 11E of the shock absorbing device bodies 10E. The shock absorbing device bodies 10E, leant on by the connecting seats 31, 32, undergo pressure, providing an attenuating effect.

Since the present invention has a plurality of elastic elements within the single shock absorbing device body 10, the rubber shock absorber of the present invention has the capability to comply with the demand for the elastic coefficient of the shock absorbing device varying in several stages. The absorbing effect of the shock absorbing device is thus enhanced. Furthermore, shock absorbing device body of the present invention, by having the characteristics described above, does not need additional attenuating elements. The present invention thus effectively simplifies shock absorbing devices and allows for shorter shock absorbing devices.

While the invention has been described with reference to preferred embodiments thereof, it is to be understood that modifications or variations may be easily made without departing from the spirit of this invention which is defined by the appended claims.

1. A rubber shock absorber, comprising:
a shock absorbing device body, made of elastic material, mounted in a shock absorbing device and absorbing pressure to which said shock absorbing device is exposed, said shock absorbing device body consisting of a plurality of sections with different diameters, with each section of said plurality of sections having a different elastic coefficient;
wherein said shock absorbing device body has an elastic coefficient that varies in several stages, so that said shock absorbing device during an absorption process goes through stages of different absorption characteristics.

2. A rubber shock absorber according to claim 1, wherein said shock absorbing device body has a central longitudinal through hole and said shock absorbing device has a guiding rod which passes through said through hole.

3. A rubber shock absorber according to claim 1, wherein said shock absorbing device body has a peripheral surface with several grooves, providing deformation space, so that said shock absorbing device body has an enhanced deformation coefficient

4. A rubber shock absorber according to claim 1, wherein said plurality of sections are arranged in decreasing diameters, having inclined peripheral surfaces.
